(19) United States
(12) Patent Application Publication
(10) Pub. No.: US 2022/0220970 A1
(43) Pub. Date: Jul. 14, 2022

(54) VARIABLE IMPELLER FOR PUMP

(71) Applicant: KOREA WATER RESOURCES CORPORATION, Daejeon (KR)

(72) Inventor: Sang Hyun OH, Daejeon (KR)

(73) Assignee: KOREA WATER RESOURCES CORPORATION, Daejeon (KR)

(21) Appl. No.: 17/302,075

(22) Filed: Apr. 22, 2021

(30) Foreign Application Priority Data
Jan. 12, 2021 (KR) 10-2021-0004117

(51) Int. Cl. F04D 29/24

(52) U.S. Cl. CPC F04D 29/247

(57) ABSTRACT

A variable impeller for a pump is proposed. The variable impeller includes a hub to which a shaft is mounted, a plurality of vanes radially arranged around the hub outward from the hub, and extension wings tightly locked to the plurality of vanes and extending length of each of the vanes. The length of the vane is adjusted in response to the pumping head that is changed by a flow rate of fluid, the pump is operated within a high efficiency section, an expensive impeller rotation speed control device is not required, and energy is reduced by reducing power consumption of the pump. In addition, during the work of changing the pumping head, the replacement of the extension wings may be quickly completed while only a part of a pump housing is opened to expose only the impeller without separating the entire assembly of the impeller from the pump.

### CROSS REFERENCE TO RELATED APPLICATION

The present application claims priority to Korean Patent Application No. 10-2021-0004117, filed Jan. 12, 2021, the entire contents of which is incorporated herein for all purposes by this reference.

### BACKGROUND OF THE INVENTION

### Field of the Invention

The present invention relates generally to a variable impeller for a pump and, more particularly, to a variable impeller capable of adjusting the length of an impeller vane in response to the pumping head of a pump.

### Description of the Related Art

When the size of a pump is determined for purchasing the pump, the actual head and the loss head are calculated. The difference between the maximum discharge level and the suction level is applied to calculation of the actual head, and the loss generated when a pipe is deteriorated is applied to calculation of the loss head, and a purchase specification is given to manufacture the pump so that the highest efficiency is achieved at the total head.

When the pump newly installed according to the purchase specification is operated in the field, a significant gap occurs between the rated head at which the highest efficiency occurs and the operating head occurring in the field, so the pump is operated at a lower head rather than a point at which the highest efficiency commonly occurs. In addition, large variation due to season and time may occur in the district heating method, such as unusually increased usage only in winter.

When the proportion of the loss head in the total head is large, the pump may deviate from the proper operating range and cause abnormality accompanied by vibration and noise. In the above case, a valve installed at an outlet is operated to generate resistance, i.e., loss. Therefore, conditions of the pump are changed so that the pump is operated at the pumping head within the proper operating range.

When only the diameter of an impeller is changed without changing the rotation speed, the power consumption is proportional to the head ratio in proportion to the square of the changed diameter ratio of the impeller. Accordingly, it is important to adjust the diameter of the impeller in order to change the head of the discharged fluid to suit the actual head that is changed during operation in the field and to use only the energy necessary to operate the pump.

Therefore, in a conventional impeller having a vane having a predetermined length, the pump cannot be operated within a high efficiency section thereof in response to the flow rate of fluid, and the power loss of the pump is increased and the power consumption thereof is increased, thereby wasting energy.

Conventionally, in order to solve the energy waste described above, a metal impeller with a different diameter and a different length of the vane is separately prepared, and when the pumping head is changed, the prepared spare metal impeller is replaced with the original installed impeller. The impeller replacement is performed by separating a shaft of the pump and the impeller assembly from the pump and then carefully replacing the precisely assembled impeller and elements related to the impeller under the supervision of a highly skilled technician. In this case, there are problems that the replacement time and cost are increased and a complicated process is accompanied when the pumping head is changed.

### DOCUMENTS OF RELATED ART

(Patent Document 1) KR No. 10-1796581 B1

### SUMMARY OF THE INVENTION

Accordingly, the present invention has been made keeping in mind the above problems occurring in the related art, and the present invention is intended to propose a variable impeller for a pump, wherein the length of a vane is adjusted in response to the pumping head that is changed by a flow rate of fluid, the pump is operated within a high efficiency section, an expensive impeller rotation speed control device is not required, and energy is reduced by reducing power consumption of the pump.

Another objective of the present invention is intended to propose a variable impeller for a pump, wherein, when the present invention is applied to the pump, replacement of an extension wing is quickly completed while only a part of a pump housing is opened to expose only the impeller without separating the entire assembly of the impeller. Whereby, the present disclosure is intended to simplify impeller replacement performed when the pumping head is changed.

In order to achieve the above objectives, according to one aspect of the present invention, there is provided a variable impeller for a pump. The variable impeller includes a hub to which a shaft may be mounted; a plurality of vanes radially arranged around the hub outward from the hub; and extension wings tightly locked to the plurality of vanes and extending length of each of the vanes.

Each of the extension wings may include: a wing portion being in close contact with an end of the vane and extending the length of the vane; and a support portion including a first support part and a second support part that support the wing portion in upward and downward directions of the wing portion.

The variable impeller may include: a first shroud and a second shroud formed by radially extending from a circumference of the hub and supporting the plurality of vanes in upward and downward directions of the shaft.

The first support part may include a protrusion protruding toward the first shroud from a surface opposing to a surface supporting the wing portion, and the first shroud may include mounting grooves each formed by depressing a surface of the first shroud for the first support part to be mounted into the mounting groove and coupling holes each formed by further depressing the mounting groove to be coupled to the protrusion of the first support part.

The first support part and the second support part may have the same section that may be perpendicular to a direction of the shaft and be aligned parallel to the shaft direction.

The second shroud may include mounting holes each having a shape corresponding to a section of the second support part perpendicular to the shaft direction, and the second support part may be positioned in each of the mounting holes.

A lower surface of the first support part and a lower surface of the first shroud may be provided on the same level, and an upper surface of the second support part and an upper surface of the second shroud may be provided on the same level.

The wing portion may include a contact surface and an extension surface, the contact surface formed in the same shape as an end section of the vane to be in contact with the end section and the extension surface formed by extending from the contact surface in a direction in which the vane may extend outward from the hub.

According to the embodiment, the length of the vane is adjusted in response to the pumping head that is changed by a flow rate of fluid, so that the pump can be operated within the high efficiency section, the expensive impeller rotation speed control device is not required, and energy can be reduced by reducing the power consumption of the pump.

In addition, according to the present invention, during changing operation of the pumping head, replacement of the extension wing can be quickly completed while only a part of the pump housing is opened to expose only the impeller, whereby, it is possible to simplify the impeller replacement performed when the pumping head is changed. Accordingly, the use of the present invention has effects of reducing impeller replacement time and cost due to simplification of the impeller replacement and of reducing the possibility of operating errors of the pump after the impeller replacement.

### BRIEF DESCRIPTION OF THE DRAWINGS

The above and other objectives, features, and other advantages of the present invention will be more clearly understood from the following detailed description when taken in conjunction with the accompanying drawings, in which:

FIG. 1 is a sectional view showing a pump to which an impeller according to an embodiment of the present invention is mounted;

FIGS. 2A to 2C are perspective views showing an extension wing according to the embodiment of the present invention;

FIG. 3 is an enlarged side view showing a main part of the impeller shown in FIG. 1;

FIG. 4 is a view showing the impeller shown in FIG. 1 without a first shroud but with a plurality of extension wings;

FIG. 5 is a view showing the impeller shown in FIG. 4 without the plurality of extension wings; and

FIG. 6 is a view showing the impeller shown in FIG. 1 without a second shroud and the plurality of extension wings.

### DETAILED DESCRIPTION OF THE INVENTION

The above and other objectives, features, and other advantages of the present invention will be more clearly understood from the following detailed description when taken in conjunction with the accompanying drawings. As for reference numerals associated with parts in the drawings, the same reference numerals will refer to the same or like parts through the drawings. It will be understood that, although the terms “first”, “second”, etc. may be used herein to describe various elements, these elements should not be limited by these terms. These terms are only used to distinguish one element from another element. Hereinafter, in the description, details of well-known features and techniques may be omitted to avoid unnecessarily obscuring the presented embodiments.

Hereinbelow, exemplary embodiments of the present invention will be described in detail with reference to the accompanying drawings, and the same reference numerals will refer to the same or like elements.

Prior to the description, in the embodiment, it is shown that a variable impeller is mounted to a double suction type centrifugal pump, but the variable impeller according to the present invention may be applied to a single suction type centrifugal pump, an axial flow type pump, a diagonal flow type pump, etc.

In addition, in various embodiments, elements having the same configuration will be representatively described in the embodiment by using the same reference numerals, and in other embodiments, configurations different from the embodiment will be described.

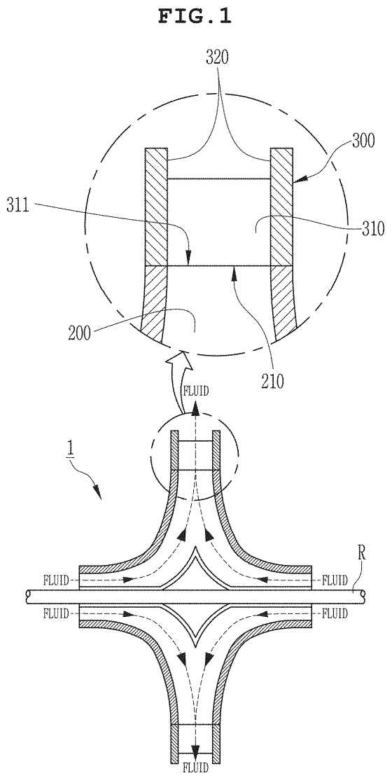

In FIGS. 1 to 6, a variable impeller 1 for a pump according to the embodiment of the present invention is shown.

The variable impeller 1 is rotatably provided in a housing (not shown) for the pump having an inlet into which a fluid is suctioned and an outlet through which the fluid is discharged.

The variable impeller 1 is configured to supply kinetic energy to the fluid suctioned through the inlet due to the rotation of a shaft R and to discharge the fluid through the outlet.

According to the embodiment of the present invention, the variable impeller 1 for the pump includes: a hub 100 to which the shaft R is mounted; a plurality of vanes 200 radially arranged around the hub 100 toward the outside of the hub 100; and extension wings 300 tightly locked to the plurality of vanes 200 and extending a length of each of the vanes.

As shown in FIGS. 1 to 6, the variable impeller 1 according to the embodiment of the present invention the pump includes the hub 100, the plurality of vanes 200, and the extension wings 300.

The hub 100 has a hollow circular sectional shape and positioned at a center portion of the impeller 1. The hub 100 is coupled to the shaft R passing therethrough and is rotated together with the shaft R.

The plurality of vanes 200 is radially arranged around the hub 100 outward from the hub 100 at intervals. Each of the vanes 200 has a predetermined length, and has a curved shape starting from an outer circumference the hub 100 with respect to a radial direction of the hub 100, for example, an arc shape with a predetermined radius of curvature. Each of the vanes 200 may have a length capable of discharging the fluid to the lowest head for the pump, for example, an effective rotation radius. In the embodiment, the vane 200 is illustrated with having an arc shape curved with respect to the radial direction of the hub 100, but the present invention is not limited thereto and the vane 200 may be formed in a linear shape.

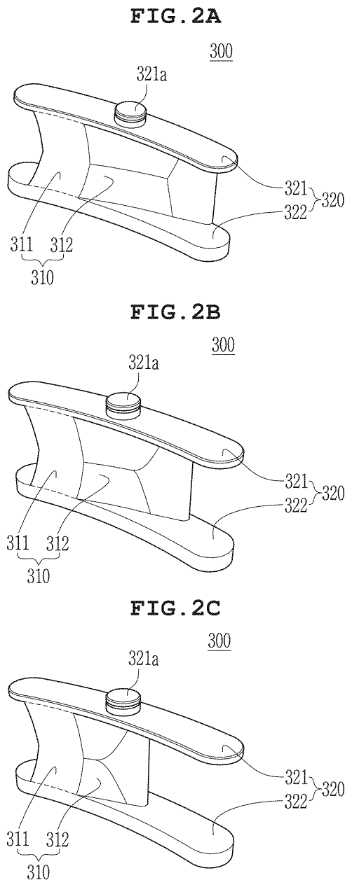

The extension wings 300 are arranged to be in close contact with the plurality of vanes 200, respectively. The extension wings 300 are arranged in the impeller 1 to be coupled to ends of the vanes 200 and variably adjust lengths of the vanes 200. Each of the extension wings 300 is in close contact with each of the vanes 200 in a longitudinal direction of the vane 200. As shown in FIGS. 2A to 2C, the variable extension wings 300 having different length may be coupled to the impeller 1, and thus, in response to change in the amount of fluid discharged from the pump due to seasonal and economic fluctuations, the extension wings 300 may be replaced with different types of extension wings 300. The extension wings 300 will be described below in detail.

As shown in FIG. 2A to 2C, the extension wings 300 according to the embodiment of the present invention is shown.

In the variable impeller 1 for the pump according to the embodiment of the present invention, the extension wing 300 may include: a wing portion 310 being in close contact with an end of the vane 200 and extending a length of the vane 200; and a support portion 320 consisting of a first support part 321 and a second support part 322 that support the wing portion 310 in upward and downward directions.

In the variable impeller 1 for the pump according to the embodiment of the present invention, the wing portion 310 may include a contact surface 311 formed in the same shape as an end surface 210 of the vane 200 to be in contact with the end surface 210 and an extension surface 312 formed by being extended from the contact surface 311 in a direction in which the vane 200 is extended outward from the hub 100.

According to the embodiment of the present invention, the extension wing 300 includes the wing portion 310 and the support portion 320.

The wing portion 310 serves to extend a length of the vane 200 by being in close contact with the end of the vane 200. The wing portion 310 has an arc shape having the same radius of curvature as the vane 200. An end of the wing portion 310 positioned in the opposite direction to the vane 200 may have a pointed shape to minimize pressure loss when the fluid passes through the impeller 1. The wing portion 310 will be described in detail with reference to FIGS. 2A to 2C. An outer surface of the wing portion 310 may consist of the contact surface 311 and the extension surface 312.

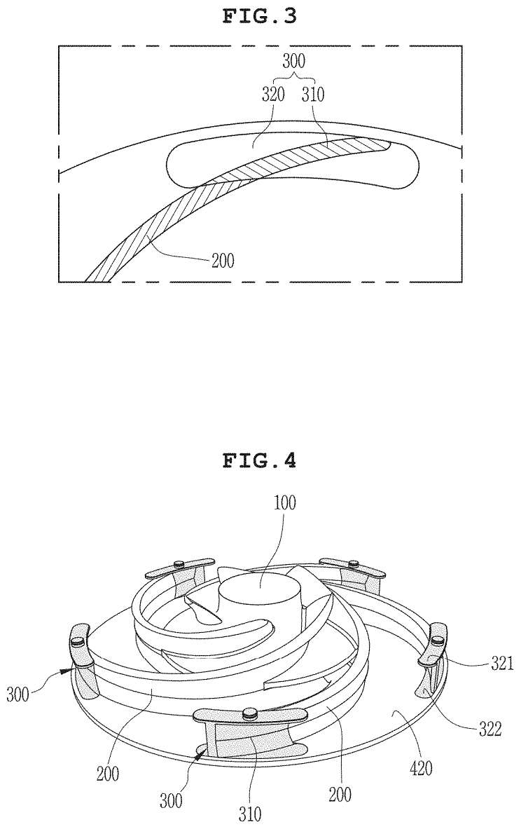

The contact surface 311 is formed in the same shape as the end surface 210 of the vane 200 to be in contact with the end surface 210. As shown in FIG. 3, side surfaces of the extension wing 300 and the vane 200 are connected to each other without unevenness. Therefore, the vane 200 and the wing portion 310 may be in close contact to be connected smoothly, so that the fluid flow may be streamlined along the vane 200 and the wing portion 310 and turbulence that interferes with the fluid flow and causes energy loss is minimized.

The extension surface 312 may be formed in an arc shape to have the same radius of curvature as the vane 200. The extension surface 312 may be formed in a smooth curved surface, and may have a protruding center portion as shown in FIGS. 2A to 2C, so that the wing portion 310 may be formed to have the thickest thickness at the extension surface 312 and may be formed to have a thinner thickness as the wing portion 310 goes outward from the extension surface 312. The above-described shape of the extension surface 312 of the wing portion 310 is designed for the fluid flow minimizing energy loss, and the shape of the extension surface 312 is not limited thereto.

The extension wings 300 having the wing portion 310 with different lengths are shown in FIGS. 2A to 2C. That is, when a length of the vane 200 is required to be adjusted at the time where the amount of fluid is changed due to seasonal and economic fluctuations, the extension wings 300 having the wing portion 310 with the appropriate length may be selected and coupled to or separated from the impeller 1.

The support portion 320 includes the first support part 321 and the second support part 322. As shown in FIGS. 2A to 2C, the first support part 321 and the second support part 322 support and fix the wing portion 310 in upward and downward directions. The upward and downward directions is a direction in which the shaft R is extended in FIG. 1, thereby the support portion 320 may be formed to support the wing portion 310 in a direction of the shaft R. The wing portion 310 and the support portion 320 may be integrally formed with each other, but are not limited thereto.

Arrangement between the vane 200, the extension wings 300, and a shroud 400 according to the embodiment of the present invention is shown in FIGS. 4 to 6.

According to the embodiment of the present invention, the variable impeller 1 for the pump may include a first shroud 410 and a second shroud 420 that are extended from a circumference of the hub 100 in a radial direction of the hub 100, and support the plurality of vanes 200 in upward and downward directions of the shaft R.

According to the embodiment of the present invention, in the variable impeller 1 for the pump, the first support part 321 may have a protrusion 321a protruding toward the first shroud 410 from the opposite surface to a wing portion 310 supporting surface. The first shroud 410 may include mounting grooves 411 formed by depressing a surface of the first shroud 410 for the first support part 321 to be mounted thereto and coupling holes 412 further depressed from the mounting grooves 411 to be coupled to the protrusion 321a.

The plurality of vanes 200 is supported by a pair of shrouds 400. The pair of shrouds 400 is provided by being radially extended from the hub 100 with the vanes 200 positioned between the pair of shrouds 400, and supports opposite ends of each of the vanes 200. The shrouds 400 support the vanes 200 in upward and downward directions of the shaft R. The pair of shrouds 400 includes the first shroud 410 and the second shroud 420. The pair of shrouds 400 is formed in a size larger than an effective rotation radius of each vane 200 in consideration of length extension of the extension wing 300 mounted to the vane 200. Each of the shrouds 400 is preferably formed to have a radius same as or larger than a rotation radius of the extension wing 300 mounted to the vane 200.

The pair of shrouds 400 is provided in the embodiment. However, the present invention may not be limited thereto, one shroud 400 may be provided in response to a type for the pump.

In FIG. 6, the first shroud 410 is shown as a view taken from a lower side thereof. The first shroud 410 may include the mounting grooves 411 and the coupling holes 412. Each of the mounting grooves 411 is a groove into which the first support part 321 is mounted, and is formed by depressing a lower surface of the first shroud 410. Accordingly, the mounting groove 411 and the first support part 321 may be formed to have sectional shapes correspond to each other. Each of the coupling holes 412 is configured to be coupled to the protrusion 321a of the first support part 321 so that the first support part 321 is locked to the first shroud 410. The protrusion 321a protrudes from the surface opposing to the surface supporting the wing portion 310 in the first support part 321 toward the first shroud 410. A coupling method between the protrusion 321a and the coupling hole 412 may be performed by the male and female coupling such as screwing, fitting, etc., but the present invention is not limited thereto.

FIGS. 4 to 6 are views showing arrangement between the vanes 200, the extension wings 300, and the shrouds 400 according to the embodiment of the present invention.

In the variable impeller 1 for the pump according to the embodiment of the present invention, the first support part 321 and the second support part 322 may match each other in sections perpendicular to the direction of the shaft R and may be aligned in the direction of the shaft R.

In the variable impeller 1 for the pump according to the embodiment of the present invention, the second shroud 420 may include mounting holes 421 each having a shape corresponding to a section of the second support part 322 perpendicular to the direction of the shaft R, and the second support part 322 may be positioned in each of the mounting holes 421.

In the variable impeller 1 for the pump according to the embodiment of the present invention, a lower surface of the first support part 321 and the lower surface of the first shroud 410 may be provided on the same level, and an upper surface of the second support part 322 and an upper surface of the second shroud 420 may be provided on the same level.

According to the embodiment of the present invention, the first support part 321 and the second support part 322 of the support portion 320 may be aligned parallel to the direction of the shaft R, and may be formed to have the same shapes in sections perpendicular to the direction of the shaft R. As described above, when the first support part 321 and the second support part 322 are arranged parallel to each other, the extension wings 300 may be easily replaced in the impeller 1. When the extension wings 300 are mounted to the impeller 1, as the first support part 321 and the second support part 322 pass through in sequence the mounting holes 421 to be described later, the extension wings 300 may be mounted to the impeller 1. Furthermore, when the extension wings 300 are separated from the impeller 1, the second support part 322 passes through the mounting holes 421 and then the first support part 321 passes through the mounting holes 421, whereby the impeller 1 and the extension wings 300 may be separated from each other. Through the replacement method, the extension wings 300 may be removed from and mounted to the impeller 1 without separation of the hub 100, the vanes 200, the shrouds 400, etc., so that replacement time and cost of the extension wings 300 may be drastically reduced. In other words, during replacement of the impeller 1, replacement of the extension wings 300 may be quickly completed while only a casing for the pump is opened and only the impeller 1 is exposed. Accordingly, replacement of the impeller 1 performed when the pumping head is changed may be simplified. Therefore, the use of the present invention causes an effect of lowering the possibility of an operation error for the pump after replacement of the impeller 1 due to simplification of the impeller replacement. Furthermore, the performance of the impeller 1 may be changed by simply replacing the extension wings 300 without replacement of the impeller 1.

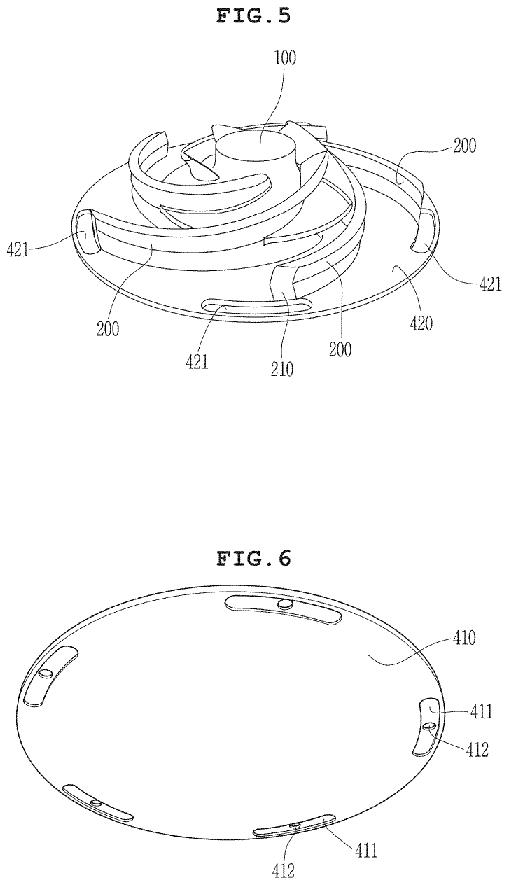

The structure of the second shroud 420 according to the embodiment of the present invention is shown in FIGS. 4 and 5. The second shroud 420 may include the mounting holes 421. Each of the mounting holes 421 may be formed in a hole passing through a surface of the second shroud 420. The mounting hole 421 may be formed on the surface of the second shroud 420 with a shape corresponding to a section of the second support part 322 in the perpendicular direction to the shaft direction. Accordingly, as the shapes of the mounting hole 421 and the second support part 322 match to each other, the second support part 322 may be positioned in the mounting hole 421. When the shapes of the mounting hole 421 and the second support part 322 match to each other, voids on the surface of the second shroud 420 are minimized during positioning of the second support part 322 in the mounting hole 421, so that mechanical vibration, turbulence of fluid, and performance degradation of the impeller 1 may be minimized.

According to the embodiment of the present invention, the lower surface of the first support part 321 and the lower surface of the first shroud 410 may be provided on the same level. When the first support part 321 is positioned in the mounting groove 411, the surface of the first support part 321 and the surface of the first shroud 410 may be provided on the same level. Therefore, during fluid flow, turbulence generated when fluid touches the surface of the first shroud 410 may be minimized. According to another embodiment of the present invention, the first support part 321 and the mounting groove 411 may be formed to have the same thickness. As described above, a structure that satisfies the condition in which the lower surface of the first support part 321 and the lower surface of the first shroud 410 are positioned on the same level may be another embodiment of the present invention.

According to the embodiment of the present invention, the upper surface of the second support part 322 and the upper surface of the second shroud 420 may be provided on the same level. When the second support part 322 is positioned in the mounting hole 421, the surface of the second support part 322 and the surface of the second shroud 420 may be positioned on the same level. Therefore, during fluid flow, turbulence generated when fluid touches the surface of the second shroud 420 may be minimized. In another embodiment of the present invention, the second support part 322 and the mounting hole 421 may be formed to have the same thickness. As described above, a structure that satisfies the condition in which the upper surface of the second support part 322 and the upper surface of the second shroud 420 may be positioned on the same level may be another embodiment of the present invention.

By using the variable impeller 1 having the above-describe configuration for the pump according to the embodiment of the present invention, the process of variably adjusting the length of the vane 200 will be described below.

First, in order to discharge fluid at the rated head which is the highest head by using the impeller 1 according to the embodiment of the present invention, as shown in FIG. 3, the extension wings 300 are tightly coupled to the ends of the vanes 200 so that each of the vanes 200 of the impeller 1 has a rotation radius corresponding to the rated head. As shown in FIG. 2A, as the extension wings 300 coupled to the impeller 1, the extension wing 300 having the longest wing portion 310 may be adopted. Whereby, the length of the vane 200, for example, the effective rotation radius of the vane 200 may be maximized

After the impeller 1 with the extension wings 300 respectively coupled to the vanes 200 is tested under a dynamic balance test to adjust the rotation balance, the impeller 1 is assembled to the pump housing.

When the impeller 1 assembled to the pump housing rotates the shaft R by a driving means (not shown), the impeller 1 is rotated. Then, a pressure difference is generated in a fluid inlet area of the vane 200 so that the fluid inflowing through the inlet for the pump housing flows into the vane 200. When the fluid flowing into the vane 200 flows along the vane 200 and the extension wing 300 as centrifugal force is applied by the rotational force of the vane 200, and is discharged at the rated head through the outlet for the pump housing.

Next, in order to discharge fluid at the lowest head by using the impeller 1 according to the embodiment of the present invention, as shown in FIG. 5, the extension wings 300 are not coupled to the ends of the vane 200 so that each of the vanes 200 of the impeller 1 has a rotation radius corresponding to the desired lowest head. Whereby, the length of the vane 200, for example, the effective rotation radius of the vane 200 is minimized.

After the impeller 1 without the extension wings 300 is tested under the dynamic balance test to adjust the rotation balance, the impeller 1 is assembled to the pump housing.

When the shaft R is rotated, the impeller 1 is rotated. Therefore, the fluid flows through the inlet for the pump housing and flows along the vanes 200 as centrifugal force is applied due to rotational force of the vanes 200, so that the fluid may be discharged through the outlet for the pump housing at the desired lowest head.

Meanwhile, in order to discharge fluid at a predetermined head within a section between the rated head and the lowest head by using the impeller 1 according to the embodiment of the present invention, as shown in FIGS. 2B and 2C, the extension wing 300 with the wing portion 310 having a middle length is tightly coupled to the end of the vane 200 so that the vane 200 of the impeller 1 has a rotation radius corresponding to the desired predetermined head. Accordingly, depending on the type of the extension wing 300 coupled to the impeller 1 while being in close contact with the vane 200, the length of the vane 200 is variably adjusted, for example, the effective rotation radius of the vane 200 is variably adjusted.

As described above, the impeller 1 in which the plurality of extension wings 300 of a desired type are tightly mounted to the vanes 200 is tested under the dynamic balance test to adjust the rotation balance, and is assembled to the pump housing.

Then, when the shaft R is rotated, the impeller 1 is rotated. Whereby, the fluid flows through the inlet of the pump housing and flows along the vanes 200 and the extension wings 300 as centrifugal force is applied due to rotation force of the vanes 200, and is discharged at the desired predetermined head through the outlet of the pump housing.

As described above, according to the present invention, the length of the vane is adjusted in response to the pumping head that is changed by a flow rate of fluid, so that the pump may be operated within a high efficiency section, an expensive impeller rotation speed control device may not be required, and energy may be reduced by reducing the power consumption of the pump.

Hereinabove, although the preferred embodiments of the present invention have been described for illustrative purposes, the present invention is not limited thereto, those skilled in the art will appreciate that various modifications, additions and substitutions are possible, without departing from the scope and spirit of the invention as disclosed in the accompanying claims.

All modifications and variations of the present invention belong to the scope of the present invention, and the specific protective scope of the present invention will be clearly understood by the accompanying claims.

What is claimed is:

1. A variable impeller for a pump, the variable impeller comprising:
a hub to which a shaft is mounted;
a plurality of vanes radially arranged around the hub outward from the hub; and
extension wings tightly locked to the plurality of vanes and extending length of each of the vanes.

2. The variable impeller of claim 1, wherein each of the extension wings comprises:
a wing portion being in close contact with an end of the vane and extending the length of the vane; and
a support portion comprising a first support part and a second support part that support the wing portion in upward and downward directions of the wing portion.

3. The variable impeller of claim 2, further comprising:
a first shroud and a second shroud formed by radially extending from a circumference of the hub and supporting the plurality of vanes in upward and downward directions of the shaft.

4. The variable impeller of claim 3, wherein the first support part comprises a protrusion protruding toward the first shroud from a surface opposing to a surface supporting the wing portion, and
the first shroud comprises mounting grooves each formed by depressing a surface of the first shroud for the first support part to be mounted into the mounting groove and coupling holes each formed by further depressing the mounting groove to be coupled to the protrusion of the first support part.

5. The variable impeller of claim 4, wherein the first support part and the second support part have the same section that are perpendicular to a direction of the shaft and are aligned parallel to the shaft direction.

6. The variable impeller of claim 5, wherein the second shroud comprises mounting holes each having a shape corresponding to a section of the second support part perpendicular to the shaft direction, and
the second support part is positioned in each of the mounting holes.

7. The variable impeller of claim 6, wherein a lower surface of the first support part and a lower surface of the first shroud are provided on the same level, and
an upper surface of the second support part and an upper surface of the second shroud are provided on the same level.

8. The variable impeller of claim 2, wherein the wing portion comprises a contact surface and an extension surface, the contact surface formed in the same shape as an end section of the vane to be in contact with the end section and the extension surface formed by extending from the contact surface in a direction in which the vane extends outward from the hub.
